(19) United States
(12) Patent Application Publication
(10) Pub. No.: US 2024/0183630 A1
(43) Pub. Date: Jun. 6, 2024

(54) CRASH RAIL WITH INTEGRATED HEAT EXCHANGING CORE

(71) Applicant: Divergent Technologies, Inc., Los Angeles, CA (US)

(72) Inventors: Michael Thomas KENWORTHY, Rancho Palos Verdes, CA (US); Narender Lakshman, Hermosa Beach, CA (US); Allyse Birken, Los Angeles, CA (US)

(21) Appl. No.: 18/483,408

(22) Filed: Oct. 9, 2023

Related U.S. Application Data
(60) Provisional application No. 63/414,851, filed on Oct. 10, 2022.

(51) Int. Cl. F28F 27/00; B60R 19/18; B60R 19/48

(52) U.S. Cl. CPC F28F 27/00; B60R 19/18; B60R 19/48

(57) ABSTRACT

The present aspects include a crash structure of a vehicle that comprises a body member, including an external wall defining a cavity. The body member defines a crush zone configured to receive a first force and to transfer a second lesser force. The crash structure further comprises a heat exchange member within the cavity that includes: a first fluid chamber with a first input port and a first output port and a second fluid chamber in thermal communication with the first fluid chamber and includes a second input port and a second output port. The heat exchange member is configured to receive a first fluid at a first temperature at the first input port and to output the first fluid at a second lower temperature at the first output port. The heat exchange member is additionally configured to receive a second fluid at a third temperature at the second input port and to output the second fluid at a fourth higher temperature at the second output port.

This application claims priority to U.S. Provisional Application No. 63/414,851 titled “CRASH RAIL WITH INTEGRATED HEAT EXCHANGING CORE,” filed Oct. 10, 2022, which is assigned to the assignee hereof, and incorporated by reference in its entirety as if fully set forth herein.

### TECHNICAL FIELD

The present disclosure generally relates to a crash or crush structure of a vehicle, and more particularly to a crash structure further including embedding and integrating heat exchanging structures within the crash structure.

### BACKGROUND

Crash or crush structures are implemented in vehicles to allow for certain areas of the structure of a vehicle to “crush” in the event of a crash to reduce the maximum impulse of the crash transferred to the vehicle's occupants. Additionally, separate heat exchanging structures are implemented in vehicles to provide cooling or heating of key components of the vehicle. These heat exchanging structures are often filled with hazardous fluids such as hot coolant or other extremely hot or otherwise dangerous fluids. During a crash these heat exchanging structures may be damaged and can therefore create potentially hazardous situations of hot liquid spewing out and burning vehicle occupants or bystanders.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, the present aspects include a crash structure of a vehicle, comprising: a body member including an external wall defining a cavity, wherein the body member defines a crush zone configured to receive a first force and transfer a second force less than the first force; and a heat exchange member within the cavity and including: a first fluid chamber including a first input port and a first output port; a second fluid chamber in thermal communication with the first fluid chamber and including a second input port and a second output port; wherein the heat exchange member is configured to receive a first fluid at a first temperature at the first input port and to output the first fluid at a second temperature at the first output port, wherein the first temperature is greater than the second temperature; and wherein the heat exchange member is configured to receive a second fluid at a third temperature at the second input port and to output the second fluid at a fourth temperature at the second output port, wherein the third temperature is less than the fourth temperature.

Another example aspect includes a crash structure wherein the external wall comprises a crush feature, and wherein the crush feature further comprises a crush initiator wall section having a second wall thickness that is less than a first wall thickness outside of the crush initiator wall section.

Another example aspect includes a crash structure wherein the crush feature is configured to create an escape channel when crushed, for the first fluid and the second fluid.

Another example aspect includes a crash structure wherein the external wall comprises a crush feature including dimples or bends.

Another example aspect includes a crash structure wherein the body member extends along a longitudinal axis that corresponds to direction of compression of the crush zone.

Another example aspect includes a crash structure wherein the first and second fluid chambers extend along the longitudinal axis.

Another example aspect includes a crash structure wherein the first and second fluid chambers include triply periodic minimal surfaces (TPMS) type cellular structures.

Another example aspect includes a crash structure further comprising a fluid containment reservoir, wherein the fluid containment reservoir is fluidly separated from at least the first fluid chamber or the second fluid chamber by an escape port configured to open in the event of a crash of the vehicle to allow at least the first or second fluid to flow into the fluid containment reservoir.

Another example aspect includes a crash structure wherein the escape port includes a crash feature configured to break open upon an increased fluid pressure of at least the first or second fluid due to the crash.

Another example aspect includes a crash structure wherein the first fluid input port and the second fluid input port are configured to be controllable by a sensor to close in response to a crash of the vehicle.

Another example aspect includes a vehicle bumper, comprising: a bumper body; and a crash structure within the bumper body, the crash structure including a body member including an external wall defining a cavity, wherein the body member defines a crush zone configured to receive a first force and transfer a second force less than the first force; and a heat exchange member within the cavity and including: a first fluid chamber including a first input port and a first output port; a second fluid chamber in thermal communication with the first fluid chamber and having a second input port and a second output port; wherein the heat exchange member is configured to receive a first fluid at a first temperature at the first input port and to output the first fluid at a second temperature at the first output port, wherein the first temperature is greater than the second temperature; and wherein the heat exchange member is configured to receive a second fluid at a third temperature at the second input port and to output the second fluid at a fourth temperature at the second output port, wherein the third temperature is less than the fourth temperature.

Another example aspect includes a crash structure wherein the external wall comprises a crush feature, and wherein the crush feature further comprises a crush initiator wall section having a second wall thickness that is less than a first wall thickness outside of the crush initiator wall section.

Another example aspect includes a crash structure wherein the crush feature is configured to create an escape channel when crushed, for the first fluid and the second fluid.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIGS. 1A and 1B are top views of an exemplary crash structure.

FIG. 2 is a zoomed in view of an exemplary heat exchanging member prior to being crushed.

FIG. 3 is a zoomed in view of an exemplary heat exchanging member after being crushed.

FIGS. 4A and 4B are top views of exemplary heat exchanging structures.

FIG. 5 is an isometric view of an exemplary triply periodic minimal surfaces heat exchanging structure.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

Aspects of the disclosure include a crash or crush structure for a vehicle including embedding and integrating heat exchanging structures within the crash structure.

In one example implementation, which should not be construed as limiting, the crash structure may include a body member configured to house a heat exchanging member. The body member is configured to absorb a force from a crash or impact and is further configured to crush in specified areas thereby transferring a second lower force to specified areas of the heat exchanging member. Additionally the heat exchanging member is configured to crush in specified areas thereby causing the fluids located within the heat exchanging member to exit through a designated escape channel and into a fluid reservoir. This causes the hazardous fluids of the heat exchanging member to be expelled in a controlled manner preventing these hazardous fluids from being ejected in a dangerous manner.

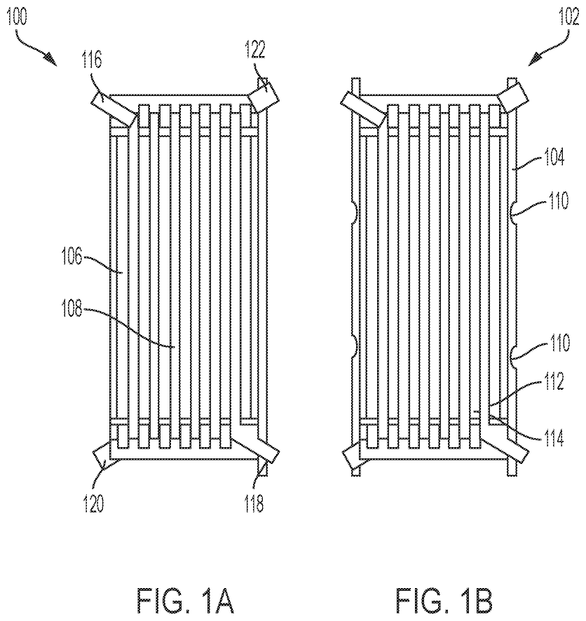

Referring specifically to FIGS. 1-3, in one example implementation that should not be construed as limiting, a crash structure 100 includes a body member 102, which further includes an external wall 104. The external wall 104, defines a cavity 106, wherein the cavity 106 is configured to house or contain a heat exchanging member 108. As can be seen in FIG. 1B, the external wall further 104 may include a plurality of crush features defined by a plurality of crush initiator wall sections 110. The crush initiator wall sections 110, may be dimples or bends located along the external wall 104 and are designed to crush or break more easily in the event of a crash or impact. In alternative terms the external wall members 104 may have a first thickness and each of the plurality of crush initiator wall sections 110 may have a second thickness less than that of the external wall members 104.

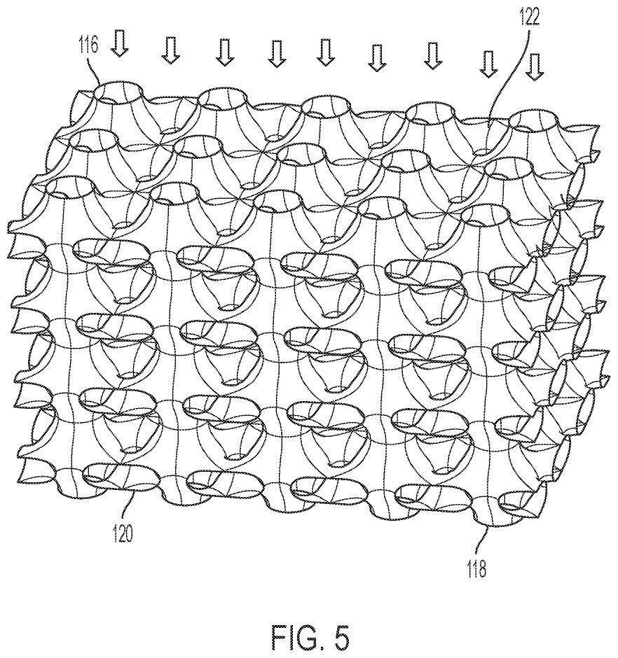

The heat exchanging member 108 includes a first fluid chamber 112 and a second fluid chamber 114, which are in thermal communication with one another. The first fluid chamber 112 may include a microtube core that may have the same or a substantially similar orientation to the external wall 104. Alternatively as can be seen in FIG. 5 the first fluid chamber 112 may include mini-channels and triply periodic minimal surfaces (TPMS) type cellular structures which may also be utilized depending on the combination of application requirements. For example as can be seen in Figures, 1-3 the first fluid chamber 112 may include a series of tubes which run longitudinally and substantially parallel to the external wall members 104. The first fluid chamber 114 may further include a first input port 116 and a first output port 118. The second fluid chamber 114 may further include a second input port 120 and a second output port 122.

Specifically as can be seen in FIGS. 1A and 1B, a first fluid may enter the first fluid chamber 112, and in turn the heat exchanging member 108, through the first input port 116. The first fluid may enter the first input port 116 at a high temperature. Similarly a second fluid may enter the second fluid chamber 114, and in turn the heat exchanging member 108, through the second input port 120. The second, heat reducing, fluid may enter the second input port 120 at a low temperature relative to the temperature of the first fluid. As can be seen in FIGS. 1A and 1B, the first fluid chamber 112 extends through the second fluid chamber 114. More specifically the tubes comprising the first fluid chamber 112 may snake throughout the second fluid chamber 114, and in turn through the second fluid located within the second fluid chamber 114. This orientation creates maximized contact between the tubes comprising the first fluid chamber 112 and the second fluid located within the second fluid chamber 114.

Once the first high temperature fluid has entered the first fluid chamber 112 it may run throughout the first fluid chamber 112, which is located within the second fluid chamber 114 and may thereby be encompassed by the second lower temperature fluid. The second fluid may include a coolant, or other fluid that has a high thermal capacity and is configured to absorb the heat being emitted from the first fluid and in turn the first fluid chamber 112. The second fluid may therefore absorb heat from the first fluid as it travels throughout the first fluid chamber 112.

The first fluid may then exit the first fluid chamber 112, and in turn the heat exchanging member 108, through the first output port 118. The first fluid may further exit the first output port 118 at a temperature substantially lower than the temperature at which it entered the first fluid chamber 112. Similarly the second fluid may exit the second fluid chamber 114, and in turn the heat exchanging member 108, through the second output port 122. The second fluid may exit the second output port 122 at a temperature substantially higher than the temperature at which it entered the second fluid chamber 114.

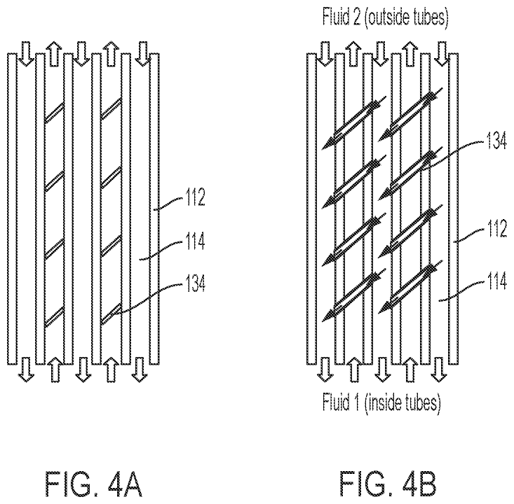

Referring to an additional example as can be seen in FIGS. 4A and 4B, the tubes of the first fluid chamber 112 may be additionally connected by support members 134. Referring specifically to FIG. 4A, these additional support members 134 or linking structures between tubes, provides manufacturing support to the structure while also serving as extended surfaces for heat transfer and dissipation of crash energy. Referring specifically to FIG. 4B, which shows a hollow tube network of support members 134, and which further allows fluid communication between parallel “tubes” which can enhance heat exchanging function by resetting boundary layer growth.

Similar to the external wall members 104, the first fluid chamber 112 may include a plurality of first fluid chamber crush initiator sections 124 and the second fluid chamber 114 may include a plurality of second fluid chamber crush initiator sections 126. Additionally included within the crash structure 100 may be a fluid containment reservoir 128, or a plurality of fluid containment reservoirs 128. The fluid containment reservoir 128 may be located adjacent to the plurality of first fluid chamber crush initiator sections 124 and the plurality of second fluid chamber crush initiator sections 126.

During a crash or impact the plurality of crush initiator wall sections 110, the plurality of first fluid chamber crush initiator sections 124, the plurality of second fluid chamber crush initiator sections 126 and the fluid containment reservoir 128 should work in unison with one another to create a controlled crush of the crash structure 100 and a controlled flow of fluid out of the heat exchanging member 108.

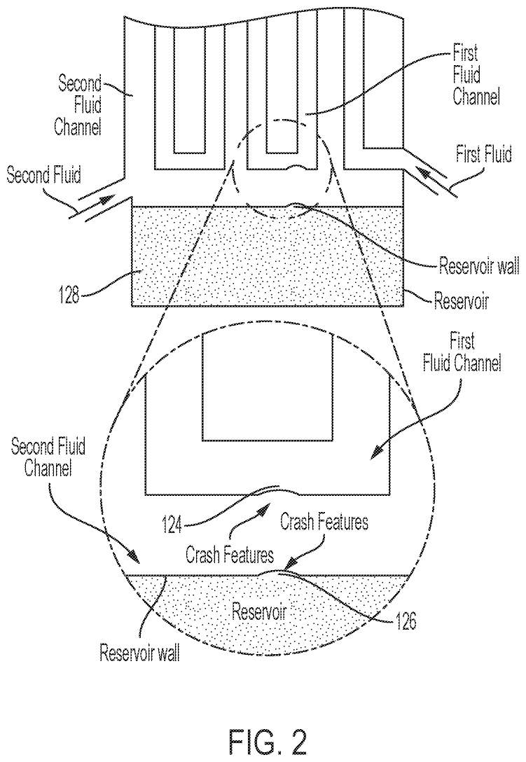

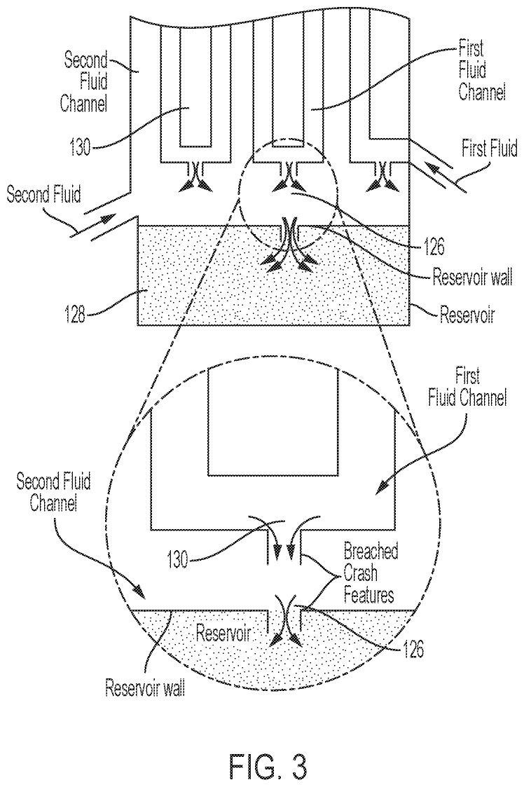

As can be seen in FIG. 1B, crush initiator wall sections 110 are arranged longitudinally along the sides of the heat exchanging member 108. In the event of an impact these weakened sections will break or crush, first causing the heat exchanging member 108, and in turn the first fluid chamber 112 and second fluid chamber 114 to compress. As can be seen in FIGS. 2 and 3, the plurality of first fluid chamber crush initiator sections 124 may be located at the bottom of the heat exchanging member 108. Similarly, the plurality of second fluid chamber crush initiator sections 126 may additionally be located at the bottom of the heat exchanging member 108. Therefore during an impact or crash when the heat exchanging member 108, including the first fluid chamber 112 and the second fluid chamber 114, is compressed by the external wall member 104 the first fluid chamber 112 and the second fluid chamber 114 may break or crush in a specified location or a plurality of specified locations at the bottom of the heat exchanging member 108. Additionally, the fluid containment reservoir 128 may be located adjacent to the plurality of second fluid chamber crush initiator sections 126.

As can be seen in FIGS. 2 and 3, the tubing of the first fluid chamber 112 may crush or break at the first fluid chamber crush initiator sections 124 located within the second fluid chamber 114 creating a first escape channel 130 or plurality of first escape channels 130 into the second fluid chamber 114. This may cause the fluid within the first chamber 112 to mix with the fluid of the second chamber 114. Simultaneously or substantially simultaneously the second fluid chamber 114 may crush or break at the plurality of second fluid chamber crush initiator sections 126. The plurality of second fluid chamber crush initiator sections 126 may then create a second escape channel 132 or plurality of second escape channels 132 into the fluid containment reservoir 128. This allows for the fluid located within the first fluid chamber 112 and the fluid located within the second fluid chamber 114 to both flow into the designated fluid containment reservoir 128 through the plurality of first and second escape channels 130, 132 created at the first fluid chamber crush initiator sections 124 and the second fluid chamber crush initiator sections 126. This in turn creates a controlled escape for the fluids located within the heat exchanging member 108 as it is compressed by the external wall 104.

In an additional example the plurality of crush initiator wall sections 110, the plurality of first fluid chamber crush initiator sections 124, the plurality of second fluid chamber crush initiator sections 126 and the fluid containment reservoir 128 may be arranged in different locations, so as to compress, thereby causing the fluid of the heat exchanging member 108 to escape at the top or the sides of the heat exchanging member 108.

In a further additional example the crash structure 100 including a body member 102, which further includes an external wall 104 and a heat exchanging member 108 may be located partially within or adjacent to a vehicle bumper. Therefore when the bumper incurs an impact, the crash structure 100 including a heat exchanging member 108 located adjacent to the bumper may crush in a controlled manner as described above. For example a bumper may incur an impact causing the bumper to deform and the bumper may then impact the external wall 104 of the crash structure 100. The plurality of crush initiator wall sections 110, the plurality of first fluid chamber crush initiator sections 124, the plurality of second fluid chamber crush initiator sections 126 and the fluid containment reservoir 128 should work in unison with one another to create a controlled crush of the crash structure 100 impacted by the bumper by the methods described above.

In the above aspects, the structure may be 3-D printed. This allows for small complex structures to be created much more easily, many of which cannot feasibly be created through the use of standard machining. This allows for the external walls and heat exchanging members to be highly variable and therefore allows for different load bearing combinations, which may be more acceptable in different applications.

1. A crash structure of a vehicle, comprising:
a body member including an external wall defining a cavity, wherein the body member defines a crush zone configured to receive a first force and transfer a second force less than the first force; and
a heat exchange member within the cavity and including:
a first fluid chamber including a first input port and a first output port;
a second fluid chamber in thermal communication with the first fluid chamber and including a second input port and a second output port;
wherein the heat exchange member is configured to receive a first fluid at a first temperature at the first input port and to output the first fluid at a second temperature at the first output port, wherein the first temperature is greater than the second temperature; and
wherein the heat exchange member is configured to receive a second fluid at a third temperature at the second input port and to output the second fluid at a fourth temperature at the second output port, wherein the third temperature is less than the fourth temperature.

2. The crash structure of claim 1, wherein the external wall comprises a crush feature, and wherein the crush feature further comprises a crush initiator wall section having a second wall thickness that is less than a first wall thickness outside of the crush initiator wall section.

3. The crash structure of claim 2, wherein the crush feature is configured to create an escape channel when crushed, for the first fluid and the second fluid.

4. The crash structure of claim 1, wherein the external wall comprises a crush feature including dimples or bends.

5. The crash structure of claim 1, wherein the body member extends along a longitudinal axis that corresponds to direction of compression of the crush zone.

6. The crash structure of claim 5 wherein the first and second fluid chambers extend along the longitudinal axis.

7. The crash structure of claim 1, wherein the first and second fluid chambers include triply periodic minimal surfaces (TPMS) type cellular structures.

8. The crash structure of claim 1, further comprising a fluid containment reservoir, wherein the fluid containment reservoir is fluidly separated from at least the first fluid chamber or the second fluid chamber by an escape port configured to open in the event of a crash of the vehicle to allow at least the first or second fluid to flow into the fluid containment reservoir.

9. The crash structure of claim 8, wherein the escape port includes a crash feature configured to break open upon an increased fluid pressure of at least the first or second fluid due to the crash.

10. The crash structure of claim 1, wherein the first fluid input port and the second fluid input port are configured to be controllable by a sensor to close in response to a crash of the vehicle.

11. A vehicle bumper, comprising:
a bumper body; and
a crash structure within the bumper body, the crash structure including a body member including an external wall defining a cavity, wherein the body member defines a crush zone configured to receive a first force and transfer a second force less than the first force; and
a heat exchange member within the cavity and including:
a first fluid chamber including a first input port and a first output port;
a second fluid chamber in thermal communication with the first fluid chamber and having a second input port and a second output port;
wherein the heat exchange member is configured to receive a first fluid at a first temperature at the first input port and to output the first fluid at a second temperature at the first output port, wherein the first temperature is greater than the second temperature; and
wherein the heat exchange member is configured to receive a second fluid at a third temperature at the second input port and to output the second fluid at a fourth temperature at the second output port, wherein the third temperature is less than the fourth temperature.

12. The crash structure of claim 11, wherein the external wall comprises a crush feature, and wherein the crush feature further comprises a crush initiator wall section having a second wall thickness that is less than a first wall thickness outside of the crush initiator wall section.

13. The crash structure of claim 12, wherein the crush feature is configured to create an escape channel when crushed, for the first fluid and the second fluid.
